(19) United States
(12) Patent Application Publication
(10) Pub. No.: US 2026/0166499 A1
(43) Pub. Date: Jun. 18, 2026

(54) METHOD AND DEVICE FOR THE DILUTION OF LIQUIDS

(71) Applicant: STRATEC SE, Birkenfeld (DE)

(72) Inventors: Stephan Habrich, Birkenfeld (DE); Rolf Lang, Birkenfeld (DE); Volker Barenthin, Birkenfeld (DE); Martin Trump, Birkenfeld (DE)

(21) Appl. No.: 19/365,518

(22) Filed: Oct. 22, 2025

(30) Foreign Application Priority Data
Oct. 25, 2024 (LU) LU103439

(51) Int. Cl. B01F 23/40; B01F 23/45; B01F 25/53; B01F 35/21; B01F 35/213; B01F 35/71

(52) U.S. Cl. CPC B01F 23/483; B01F 23/45; B01F 25/53; B01F 35/2112; B01F 35/2116; B01F 35/213; B01F 35/712; B01F 35/71761; B01F 35/717613; B01F 35/718051

(57) ABSTRACT

A system for the mixing of two liquids, comprising a first container comprising a dilutant, wherein the first container is connected to a diaphragm pump which is connected to an intermediate container; a second container comprising a concentrate, wherein the second container is connected to a piston pump which is connected to an intermediate container; wherein the intermediate container is connected to a liquid level sensor; as well as a method for diluting a concentrate, comprising the steps of pumping a dilutant which is stored in a first container with a diaphragm pump into an intermediate container; pumping a concentrate which is stored in a second container with a piston pump into the intermediate container.

### CROSS REFERENCE TO RELATED APPLICATIONS

The present application claims priority of Luxembourg patent application LU103439 filed on Oct. 15, 2024. The aforementioned application is hereby incorporated by reference in its entirety.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND OF THE DISCLOSURE

Field of the Disclosure

The present disclosure relates to a method and device for the dilution of liquids.

### Brief Description of the Related Art

Automated analyser systems for use in clinical diagnostics and life sciences are produced by a number of companies. For example, STRATEC® SE, Birkenfeld, Germany, produces a number of devices for specimen handling and detection for use in automated analyser systems and other laboratory instrumentation.

A large number of different liquids are used in analysis systems for human diagnostics. System fluids such as wash buffers play a major role here. These are usually used to purify the sample. Depending on the sample throughput of an instrument, several tens of litres can be consumed per day. For the user of the device, this means a constant supply of wash buffer. Depending on the volume of the containers, their weight when full means additional physical strain.

In addition to ergonomic aspects, economic/logistical factors also play a role. For example, shipping and storing the filled containers, sometimes worldwide, involves high costs, as the size and weight of the packs cause higher costs.

To avoid these disadvantages, so-called dilution modules are used, especially for high-throughput instruments. These work with a concentrate of the respective wash buffer and mix it with deionised water in the correct volumetric ratio. This is always available in laboratories. The analysers can therefore even be connected centrally to the laboratory's water treatment system.

Publishes UK patent application GB 2502584 A discloses a mixing pump for providing a mixture of a first liquid and an at least second liquid comprising a first pump pumping the first liquid along a first tube at a first pump rate, a second pump pumping the second liquid along a second tube at a second pump rate, a gear box connected the first pump and the second pump for adjusting a ratio of the first pump rate and the second pump rate and a mixing tube which the first tube and the second tube join into for mixing of the liquids. The first and second pumps may be peristaltic pumps. Preferably a single drive drives the first pump, second pump and gear box. A method of providing a mixture of a first liquid and an at least second liquid comprises pumping a first liquid along a first tube, pumping a second liquid along a second tube, mixing the two fluids in a mixing tube which is connected to the first and second tube and adjusting the ratio of the flow of the first and second liquids using a gear box.

One disadvantage of this solution is that the rigid system with only one peristaltic pump results in increased wear. On the one hand, the peristaltic hose itself is subject to wear. On the one hand, the peristaltic tube itself is subject to wear. The significantly different speeds between cassette 1 and 2 result in a different wear pattern, which can ultimately lead to a drift in the dilution over time. In addition, there are further speed-related differences in wear between the mechanical components of cassette 1 and 2 as well as wear on the actual gearbox. In addition to the wear-related drift in the dilution, peristaltic pumps are generally not considered to be precise, which also has a fundamental influence on the accuracy of the overall system

Solutions with dilution via gear pumps are also known from the state of the art. In this solution, up to four different wash buffer concentrates can be diluted. The respective concentrate is switched into the process via hose pinch valves. Gear pumps are used to set the individual dilution rate. However, these continuously pumping pumps must be regulated to the volume flow. For this purpose, two flow sensors are used to monitor the respective line. A conductivity sensor also monitors the correct mixing ratio. Downstream of the conductivity sensor, the line branches onto two further pinch valves. These control whether an i.o. dilution is fed into the process or whether an n.i.o. dilution must be pumped into the liquid waste

This solution minimizes handling and storage effort. In terms of ergonomics, the user only has to add a bottle with a maximum of a few liters of concentrate to the instrument.

One disadvantage of this solution is that flow sensors for volume flow monitoring are unavoidable due to the continuously pumping gear pumps. Although the volume can be determined precisely here, a conductivity sensor is also used. This overdetermination generates unnecessarily high costs. In addition, the conductivity sensor does not take into account variances in the output concentrate. This raises the question of which value to regulate to. On the one hand, control can be volumetric via the flow sensors, or to an absolute conductivity value. However, both at the same time would be contradictory. This system generates higher costs due to the use of gear pumps, hose pinch valves and sensors as well as the associated control system. By using pinch valves, the pipes in the system become a wearing part. Due to the ductility and compression set of the hose material, it deforms over time and may change its physical properties (e.g. loss of flexibility, increasing hardness). This means that the affected lines in the system become a part that has to be replaced regularly, which also increases costs. The conductivity sensor can also be subject to wear due to its electrode. In addition, conductivity sensors must normally be stored in a reference electrolyte to prevent the electrode from drying out and the measured values from drifting. The maintenance of the sensor system is therefore also associated with costs.

Published U.S. Pat. No. 6,513,964 B1 discloses an apparatus for mixing and diluting a concentrated liquid lubricant and a dilution material to form a diluted lubricant solution and more particularly a mass balance proportioner for weighing and mixing a concentrated lubricant and a dilution material to form a diluted lubricant having a predetermined dilution ratio based upon weight of concentrated lubricant to weight of dilution material. The disclosed device uses as preferred embodiment a double diaphragm pump as lubricant pump and provides a mass balance proportioner which weighs both the concentrated lubricant and the dilution material.

Published European patent EP 0 670 010 B1 discloses a mixing pump for liquids comprised of a pressure fluid driven two-chamber pumping unit and a two-chamber feeding unit for supply of an additive, which is to be mixed, in both of which the chambers are separated from each other with a piston or a membrane. The pressure fluid driven pumping unit is connected by means of arms, which transmit the pumping motion to a steplessly adjustable two-chamber piston pump or membrane pump that is utilized as a feeding unit. It is to be noted that the mixing pump uses the membrane pump for the mixing of an oil and water.

Published U.S. patent application US 2023/069896 A1 discloses a system for producing fluid for peritoneal dialysis (PD) is disclosed. The system includes a fluid path including two or more PD concentrate connectors that are each connected to a source of PD concentrate fluid, and an inlet connector connected to a fluid line arranged for transportation of effluent fluid from a patient. The system also includes a forward osmosis (FO)-unit including a draw side and a feed side separated by a FO-membrane. The FO-unit is fluidly connected to the fluid path and receives one or more PD concentrate fluids at the draw side and the effluent at the feed side. Water is transported from the effluent to the one or more PD concentrate fluids through the FO-membrane via an osmotic pressure gradient between the draw side and the feed side, thereby diluting the one or more PD concentrate fluids into a diluted PD concentrate fluid.

The present invention is intended to show how a system for the targeted dilution of these wash buffer concentrates can be realised with as little effort as possible.

### SUMMARY OF THE DISCLOSURE

The present disclosure provides a system for the mixing of two liquids, comprising a first container comprising a dilutant, wherein the first container is connected to a diaphragm pump which is connected to an intermediate container; a second container comprising a concentrate, wherein the second container is connected to a piston pump which is connected to an intermediate container; wherein the intermediate container is connected to a liquid level sensor.

An embodiment of the system according to the present disclosure comprises a piston pump which is free of wear parts.

It is further intended that the diaphragm pump comprises volume or flow sensors.

In an embodiment of the system, the intermediate container is connected to an agitator.

It is also envisaged that the intermediate container comprises a circulation pump.

The intermediate container comprises in an embodiment an outlet for providing the diluted concentrate.

It is also envisaged that the liquid level sensor is connected to a controller for controlling amount of provided dilutant, concentrate and the total volume in the intermediate container.

The system comprises in an embodiment first and second container which are connected to a valve for switching between first and second container, wherein the valve is connected to a piston pump which is connected to an intermediate container, wherein the intermediate container is connected to a liquid level sensor.

It is further envisaged that the first container is connected to a first valve which is connected to the piston pump, and the second container is connected to a second valve which is connected to the piston pump, wherein the piston pump is connected to a third valve which is connected to a waste and a fourth valve for closing the fluidic path, wherein the fourth valve is connected to the intermediate container.

It is intended that the system comprises bubble sensors arranged downstream of the first and second valve and upstream of the third valve.

Another object of the present disclosure relates to a method for diluting a concentrate, comprising the steps of pumping a dilutant which is stored in a first container with a diaphragm pump into an intermediate container; pumping a concentrate which is stored in a second container with a piston pump into the intermediate container.

The method comprises in an embodiment the step of determining the amount of pumped dilutant and pumped concentrate with a liquid level sensor which is connected to the intermediate container.

It is intended that method comprises in an embodiment the step of determining the total volume in the intermediate tank with the liquid level sensor.

It is envisaged that the method comprises in an embodiment the step of monitoring the volume or flow of the pumped dilutant with volume or flow sensors attached to the diaphragm pump.

The method comprises in an embodiment the step of agitating the intermediate container for improving mixing of dilutant and concentrate.

It is intended that the method comprises the step of circulating the liquid in the intermediate container with a circulation pump.

The method comprises in an embodiment the step of providing the diluted concentrate through an outlet

The foregoing summary is not intended to summarize each potential embodiment or every aspect of the present disclosure.

### BRIEF DESCRIPTION OF THE DRAWINGS

The disclosure will be described based on figures. It will be understood that the embodiments and aspects of the disclosure described in the figures are only examples and do not limit the protective scope of the claims in any way. The disclosure is defined by the claims and their equivalents. It will be understood that features of one aspect or embodiment of the disclosure can be combined with a feature of a different aspect or aspects of other embodiments of the disclosure, in which:

FIG. 1 shows a first embodiment a system according to the present disclosure for the dilution of a medium.

FIG. 2 shows a second embodiment of a system according to the present disclosure comprising a valve for switching between first and second container.

FIG. 3 shows an embodiment for diluting concentrates using a piston pump for producing a dilution.

### DETAILED DESCRIPTION OF THE DISCLOSURE

The technical problem is solved by the independent claims. The dependent claims cover further specific embodiments of the disclosure.

The present disclosure relates to the mixing of two volumes of liquids, and uses a low-precision diaphragm pump for pumping a larger volume of a first liquid which is a dilutant in combination with appropriate process monitoring, e.g. level sensors. In addition, a high-precision piston pump is used to deliver a smaller volume of a second liquid which is a concentrate, wherein process monitoring is not required due to the high precision of the piston pump. An intermediate container for holding both liquid volumes and, if necessary, for mixing both components, e.g. by an agitator, is also used.

A diaphragm pump is used as low-precision pump to pump for instance deionised water. Although diaphragm pumps are not designed for a precise and accurate delivery of volumes, they are appropriate to deliver accurate volumes in combination with process monitoring.

A piston pump is used as precision pump used to deliver a concentrate which is to be diluted. These pumps do not achieve high volume flows due to the non-continuous delivery but can deliver smaller volumes with high precision and accuracy. The so-called concentrate is also designated as medium and the use of a concentrate-separated pump is particularly recommended when handling saline concentrates. In classic precision pumps such as piston pumps, the piston seal is a wearing part. Its service life depends largely on the medium to be pumped. A medium or concentrate containing salt in particular tends to crystallise, which would have a negative effect on the service life of the piston pump's seal. The present disclosure therefore utilises a piston pump that does not contain any wear parts for a predetermined service life.

By using a volume- or flow-monitored diaphragm pump for the dilutant, e.g. deionised water, as well as a concentrate-separated piston pump for the concentrate, a precise dilution system can be implemented with little effort.

Both liquids can be mixed by turbulence as they flow into the intermediate container. If the turbulence is not sufficient, mixing can also be improved using an agitator or a circulation pump.

The intermediate container therefore has two basic tasks:
1. Providing the finished concentrate for further use; and
2. Serving as a mixing container for both liquids.

A liquid level sensor is used to monitor the amount of dilutant, e.g. deionised water, pumped by the diaphragm pump. The liquid level sensor also monitors the total liquid level in the intermediate container.

### Detailed Description of the Drawings

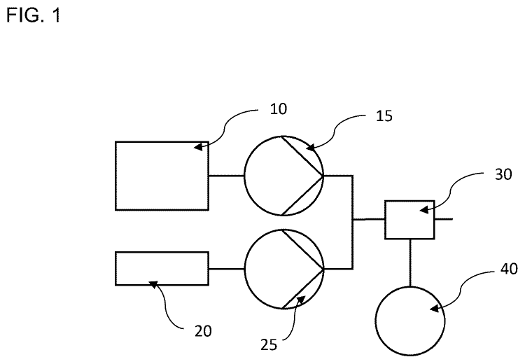

FIG. 1 shows a first embodiment of a system according to the present disclosure for the dilution of a concentrate. A first container 10 contains a dilutant, e.g. deionized water. A second container 20 contains a concentrate which is to be diluted. A diaphragm pump 15 is connected to the first container 10 and intermediate container 30 for pumping the dilutant into intermediate container 30. A piston pump 25 is connected to the second container 20 and intermediate container 30 for pumping the concentrate into intermediate container 30.

Liquid level sensor 40 is connected to intermediate container 30 and used for monitoring the pumped liquid amount by the diaphragm pump as well as for determining the total liquid level in intermediate container 30. Liquid level sensor 40 is also used for monitoring the liquid amounts of the one after the other inflowing dilutant and concentrate. The mixing ration can thus be determined by using liquid level sensor 40 for determining the ratio between the liquid volumes of dilutant and concentrate pumped into intermediate container 30.

A first alternative approach for diluting concentrates uses a time-controlled valve. A diaphragm pump and a solenoid changeover valve (3/2 valve) are used to achieve the correct mixing ratio. The diaphragm pump is characterised by a very constant delivery rate at constant back pressure. In this case, both liquids—deionised water as dilutant and concentrate—are pumped by this pump at the same flow rate. The changeover valve merely switches back and forth between the two liquids. An exact ratio between the two liquids can be set via the timing of this switchover and the constant flow rate of the pump.

This system only requires a single pump with a constant flow rate. Any tolerances due to the switching times of the valve can be compensated over the operating time. The longer the system runs, the lower is the influence of the switching time tolerances. An intermediate tank collects both liquids. If the turbulence in the tank is not sufficient due to the liquids flowing in serially, they can be actively mixed there, e.g. by an agitator. A level sensor or a load cell can be attached to the tank to monitor the process.

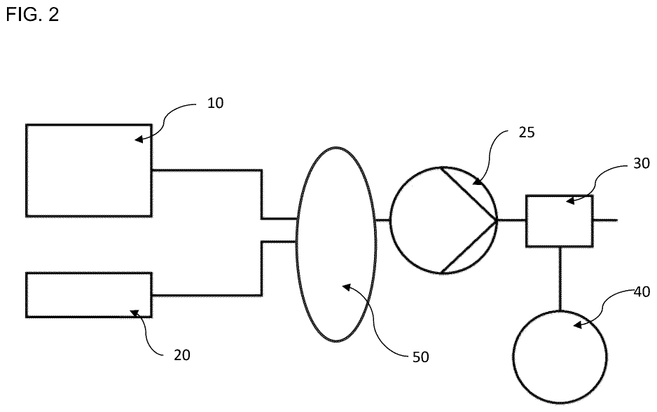

FIG. 2 shows such an alternative to a system according to the present disclosure comprising a valve 50 arranged between first and second container 10, 20 and precision pump 25 for switching between first and second container 10, 20. 3/2 valve 50 is connected to piston pump 25. The intermediate container 30 is connected to piston pump 25. A liquid level sensor 40 which is connected to intermediate container 30 determines the liquid level in intermediate container 30 as well as the provided volumes of dilutant and concentrate.

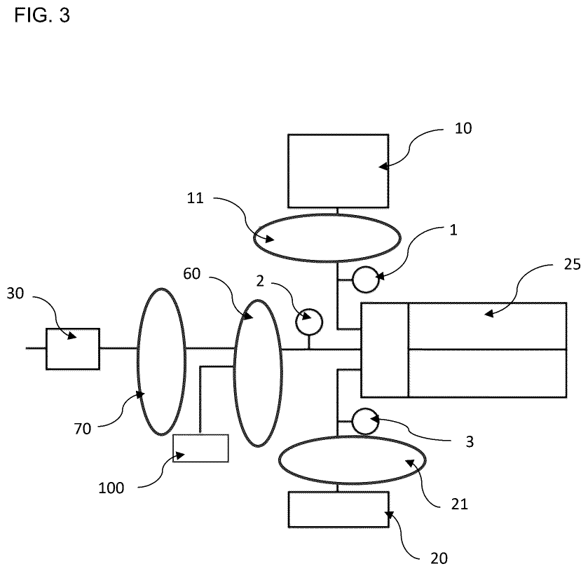

Another alternative approach relates to diluting concentrates using a piston pump for producing a dilution. FIG. 3 shows such an alternative to the subject atter of the present disclosure. A first container 10 comprising the dilutant is connected to a first valve 11 which is connected to the piston pump 25. A second container 20 comprising the concentrate is connected to a second valve 21 which is also connected to the piston pump 25. First and second valve 11, 21 are switched so that the liquids can flow into the pump chamber in series. The pressure-side line connecting the piston pump 25 to the intermediate container 30 also comprises two valves 60, 70. Firstly, a switching valve 60 is arranged downstream of the piston pump 25 which switches between the intermediate container 30 and a liquid waste 100. A closing valve 70 is arranged between switching valve 60 and intermediate container 30 so that the line can be closed while the liquids are sucked in from first and second container 10, 20. It is not necessary to monitor the individual volumes of the liquids, because the necessary precision is already generated by the piston pump. However, the lines for concentrate, dilutant and to the intermediate tank are monitored with bubble sensors 1, 2, 3. Air bubbles in the line will be detected, which indicate an incorrect volume for the dilution and thus potentially an incorrect dilution.

It is to be noted that published U.S. Pat. No. 6,513,964 B1 discloses a lubricant supply pump fand a lubricant deliver pump, wherein the lubricant supply pump is in a preferred embodiment a double diaphragm pump. No pump for the diluent is provided.

Published European patent application EP 0 670 0101 B1 discloses no intermediate tank for mixing but uses a pressure fluid driven two-chamber pumping unit and a two-chamber feeding unit for supply of an additive, which is to be mixed, in both of which the chambers are separated from each other with a piston or a membrane. In addition, membrane pump and piston pump are mounted by means of articulated joints.

No teaching is present to use the pumps of EP 0 670 010 B1 and disconnect them and further use an intermediate tank of U.S. Pat. No. 6,513,964 B1 for mixing diluent and concentrate. EP 0 670 010B1 goes back to a priority in 1990, whicle U.S. Pat. No. 6,513,964 B1 goes back to a priority in 2001. If the combination of the documents would have been obvious, it should have been possible to provide a novelty destroying document in 2025. Obviously, the skilled person would not take from the two mentioned documents the claimed system and method of the present disclosure.

The advantageous of a system according to the present disclosure can be summarised as follows:
The simple design of the system results in high robustness and low susceptibility to errors.
The system achieves a high degree of precision and accuracy in the mixing ratio in relation to the economic outlay.
A high throughput can be achieved through the targeted use of different pump concepts

It is advantageous that a piston pump as precision pump is only used to deliver the concentrate in a system according to the present disclosure. The diaphragm pump which conveys the dilutant, e.g. deionised water, is considerably cheaper in comparison to the piston pump. The necessary process monitoring can be realised by a simple level sensor so that the overall module is significantly more economical than comparable systems with sufficient accuracy.

Reliability is essential in automated analysis systems which are used for diagnostic purposes for instance. The simple design of the system allows to reduce the overall complexity to a minimum. It is thus possible to construct a system with just a few components which can remain in an instrument without wear over its entire service life.

Although the present system is based on a simple structure, a very precise mixing ratio can be achieved with the resulting effort. The larger volume proportion of the dilutant is pumped with sufficient accuracy by the imprecise diaphragm pump. Exact dosing is nevertheless possible by regulating to the measured value of the level sensor.

The low volume fraction is delivered by the precision pump. This is already sufficiently accurate by design and requires no further regulation to a target value.

With the use of a diaphragm pump, which can be assumed to deliver continuously in the application, the overall system achieves a high throughput. In this application, the precision pump, which only achieves a low throughput due to the switched intake and discharge of the liquid, only generates the concentration volume which is required in much smaller quantities.

The movement of the piston causes friction between the cylinder and the piston seal, which in turn leads to seal wear. Many piston seals function by means of a thin film of liquid on which the seal can slide over the inner surface of the cylinder. However, this can be problematic when pumping wash buffer. Due to its high concentration of salts, the wash buffer concentrate tends to crystallise as soon as the aqueous phase begins to condense. The resulting salt crystals are much harder than the piston seal and can cause accelerated wear. To prevent rapid crystallisation in the pump chamber, premature wear can be prevented by the sequential inflow of the liquids, for example first the deionised water, then the concentrate.

In many dilution systems, forced mixing must take place in the intermediate tank as the two liquids do not have optimum solubility in each other. Often the liquids are also fed sequentially into the intermediate tank. If both liquids flow in parallel in one line, laminar flow conditions result due to the low volume flows. This means that both liquids flow ‘side by side’ through the pipe but only mix through inefficient diffusion at the boundary layer. The laminarity prevents turbulence which could force the mixing. In the present invention, there are several possibilities for passive mixing. Firstly, by the sequential flow of the liquids into the pump chamber. For example, the deionised water can be drawn in first as described above. A suitable pre-distribution and nozzle geometry can then be used to distribute the concentrate into the water as soon as it is sucked in. As soon as the mixture is then delivered to the intermediate tank, a static mixer could force additional turbulence and thus final mixing

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

### REFERENCE NUMERALS

1, 2, 3 bubble sensors
10 first container
11 first valve
15 diaphragm pump
20 second container
21 second valve
25 piston pump
30 intermediate container
40 liquid level sensor
50 3/2 valve
60 switching valve
70 closing valve
100 liquid waste

We claim:

1. A system for the mixing of two liquids, comprising:
a first container comprising a dilutant, wherein the first container is connected to a diaphragm pump which is connected to an intermediate container;
a second container comprising a concentrate, wherein the second container is connected to a piston pump which is connected to the intermediate container;
wherein the intermediate container is connected to a liquid level sensor.

2. The system of claim 1, wherein the piston pump is free of wear parts.

3. The system of claim 1, wherein the diaphragm pump comprises volume or flow sensors.

4. The system of claim 1, wherein the intermediate container is connected to an agitator.

5. The system of claim 1, wherein the intermediate container comprises a circulation pump.

6. The system of claim 1, wherein the intermediate container comprises an outlet for providing the diluted concentrate.

7. The system of claim 1, wherein the liquid level sensor is connected to a controller for controlling amount of provided dilutant, concentrate and the total volume in the intermediate container.

8. The system of claim 1, wherein first and second container are connected to a valve for switching between first and second container, wherein the valve is connected to a piston pump which is connected to an intermediate container, wherein the intermediate container is connected to a liquid level sensor.

9. The system of claim 1, wherein the first container is connected to a first valve which is connected to the piston pump, and the second container is connected to a second valve which is connected to the piston pump, wherein the piston pump is connected to a third valve which is connected to a waste and a fourth valve for closing the fluidic path, wherein the fourth valve is connected to the intermediate container.

10. The system of claim 9, comprising bubble sensors arranged downstream of the first and second valve and upstream of the third valve.

11. A method for diluting a concentrate, comprising the steps of:
Pumping a dilutant which is stored in a first container with a diaphragm pump into an intermediate container; and
Pumping a concentrate which is stored in a second container with a piston pump into the intermediate container, wherein the intermediate container is connected to a liquid level sensor.

12. The method of claim 11, comprising the step of determining the amount of pumped dilutant and pumped concentrate with a liquid level sensor which is connected to the intermediate container.

13. The method of claim 11, comprising the step of determining the total volume in the intermediate tank with the liquid level sensor.

14. The method of claim 11, comprising the step of monitoring the volume or flow of the pumped dilutant with volume or flow sensors attached to the diaphragm pump.

15. The method of claim 11, comprising the step of agitating the intermediate container for improving mixing of dilutant and concentrate.

16. The method of claim 11, comprising the step of circulating the liquid in the intermediate container with a circulation pump.

17. The method of claim 11, comprising the step of providing the diluted concentrate through an outlet.
